(19) United States
(12) Patent Application Publication
(10) Pub. No.: US 2005/0149955 A1
(43) Pub. Date: Jul. 7, 2005

(54) Handle structure and LCD arrangement of a DVD player and mold for molding said handle structure on said LCD case

(76) Inventor: Juen-Tien Peng, Chung Li (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/779,716

(22) Filed: Feb. 18, 2004

(30) Foreign Application Priority Data
Jan. 5, 2004 (TW) 93200122

(51) Int. Cl. G11B 33/02

(52) U.S. Cl. 720/600

(57) ABSTRACT

A handle structure and LCD arrangement of a DVD player is disclosed to have a handle structure directly molded on the LCD case of a DVD player by a mold, the handle structure having a transversely extended top grip with a downwardly extended outer flange, a support, and a hand hole defined between the top grip and the support. The mold is formed of a female defining a cavity and a male die having a protruding portion insertable into the cavity.

### BACKGROUND OF THE INVENTION

1. Field of the Invention

The present invention relates to a DVD player having a LCD for video output and more particularly, to a handle structure and LCD arrangement of a DVD player, which comprises a handle structure directly molded on the LCD case of the DVD player.

2. Description of the Related Art

DVD player is a product of high-tech following the development of electronic technology and video media. It is popularly invited for the advantages of high mobility and capable of playing of digital video disks and the like anywhere. For easy carrying by hand, a DVD player is equipped with a handle. As shown in FIG. 1, a handle 91 is fastened to the back side of the LCD case 90 with screws. The handle 91 has a flange 92 curved forwardly downwards for grasping of the hand. Because the handle 91 is fastened to the LCD case 90 with screws, the installation of the handle complicates the fabrication procedure of the DVD player. After a long use, the tie screws may loose, and the handle may vibrate or drop from the LCD case. Further, because the tie screws are not kept from sight, they destroy the sense of beauty of the DVD player.

Therefore, it is desirable to provide a handle structure and LCD arrangement of a DVD player that eliminates the aforesaid drawbacks.

### SUMMARY OF THE INVENTION

The present invention has been accomplished under the circumstances in view. It is the main object of the present invention to provide a handle structure and LCD arrangement of a DVD player, which has the handle structure directly molded on the LCD case to save the manufacturing cost of the DVD player. It is another object of the present invention to provide a handle structure and LCD arrangement of a DVD player, which has the handle structure formed integral with the LCD case, causing a sense of beauty.

To achieve these and other objects of the present invention, the handle structure and LCD arrangement of a DVD player comprises a LCD case, a handle structure, and a mold adapted to mold the handle structure on the LCD case. The handle structure comprises a transversely extended top grip with a downwardly extended outer flange, a support, and a hand hole defined between the top grip and the support. The mold is formed of a female defining a cavity and a male die having a protruding portion insertable into the cavity.

### BRIEF DESCRIPTION OF THE DRAWINGS

FIG. 1 is a rear elevational view of a DVD player showing a handle structure provided at the back side of the LCD case according to the prior art.

FIG. 2 is a rear elevational view of a DVD player showing a handle structure provided at the back side of the LCD case according to the present invention.

FIG. 3 is a rear side view of the present invention.

FIG. 4 is a side view in section of a part of the present invention.

FIG. 5 is a schematic drawing showing the female die and the male die closed according to the present invention.

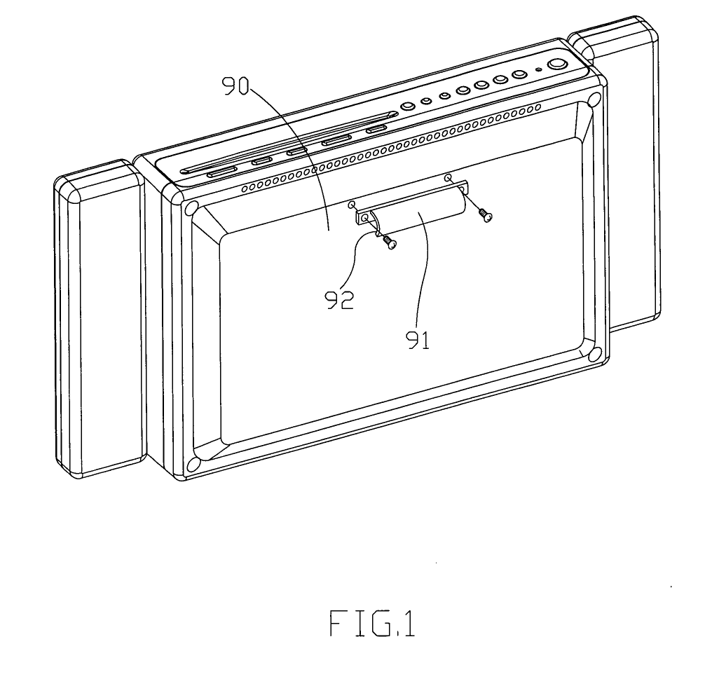

### DETAILED DESCRIPTION OF THE PREFERRED EMBODIMENT

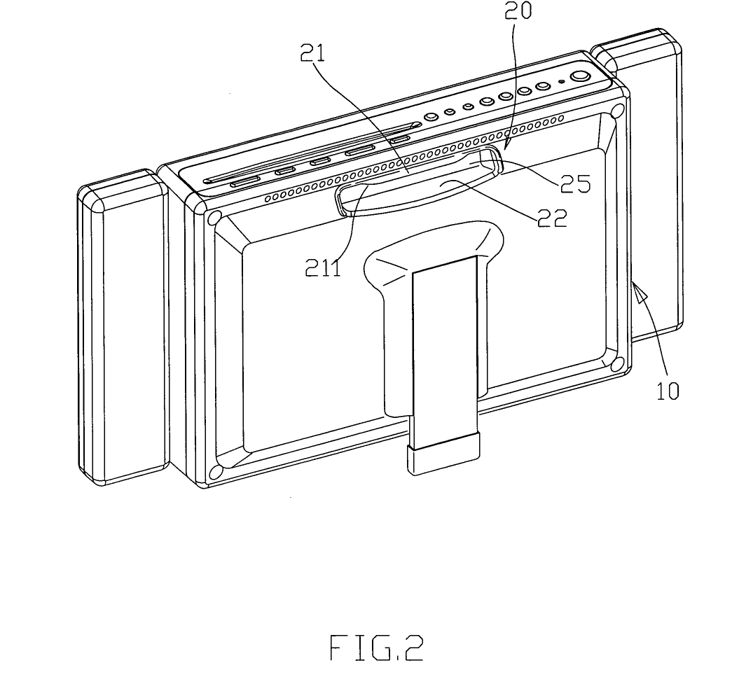

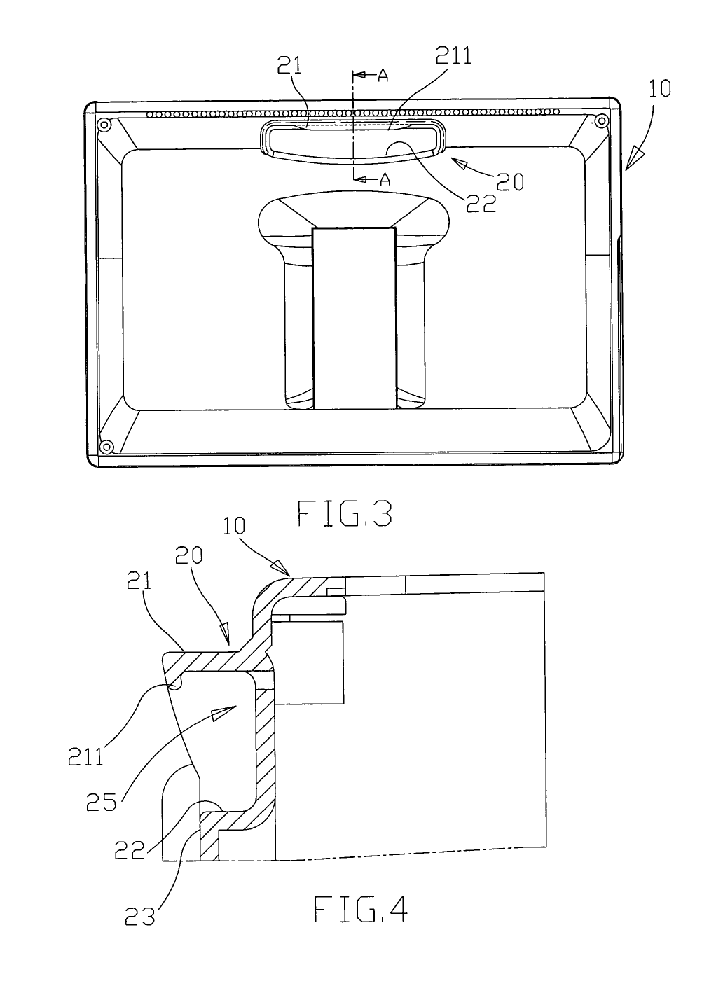

Referring to FIGS. 2, 3, and 4, a handle structure and LCD arrangement of a DVD player is shown comprising a LCD case 10 formed of a front shell and a back shell, and a handle structure 20 provided at the LCD case 10. The handle structure 20 comprises a transversely extended top grip 21 and a bottom support 22 molded on the LCD case 10 near the top side, and a hand hole 25 defined between the top grip 21 and the bottom support 22. The top grip 21 protrudes perpendicularly from the LCD case 10 to a distance over the width between the LCD case 10 and the vertical outer wall 23 of the bottom support 22, and terminates in a downwardly extended flange 211 convenient for the grasping of the hand.

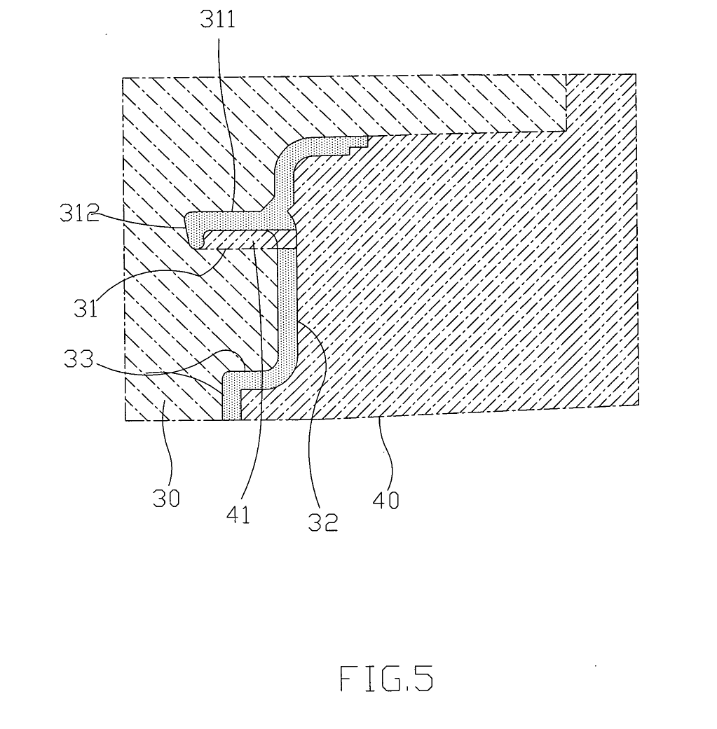

Referring to FIG. 5, the aforesaid handle structure 20 is molded from plastics by means of the use of a female die 30 and a male die 40. The female die 30 comprises a cavity 31 adapted to mold the top grip 21. The male die 40 comprises a protruding portion 41 corresponding to the cavity 31 of the female die 30. When closed the female die 30 and the male die 40, the protruding portion 41 of the male die 40 is inserted into the lower side of the cavity 31 of the female die 30, thereby defining the cavity 31 into a transversely extended top molding space 311 and a vertically extended side molding space 312 adapted to mold the top grip 21 and the downwardly extended flange 211 (see also FIG. 4).

When closed the female die 30 and the male die 40, a longitudinal molding space 32 is defined in between the female die 30 and the male die 40 and spaced below the transversely extended top molding space 311, and an angled molding space 33 is defined in between the female die 30 and the male die 40 and forwardly curved from the bottom side of the longitudinal molding space 32 and then turned vertically downwards at an offset location relative to the vertically extended side molding space 312. The transversely extended top molding space 311 and the vertically extended side molding space 312 are adapted to mold the bottom support 22 and the vertical outer wall 23.

As indicated above, the handle structure of the present invention is directly molded on the LCD case of the DVD player by means of the aforesaid female die and male die. Because the handle structure is directly molded on the LCD case, it causes a sense of beauty.

A prototype of handle structure and LCD arrangement of a DVD player has been constructed with the features of FIGS. 2˜5. The dehydrator functions smoothly to provide all of the features discussed earlier.

Although a particular embodiment of the invention has been described in detail for purposes of illustration, various modifications and enhancements may be made without departing from the spirit and scope of the invention. Accordingly, the invention is not to be limited except as by the appended claims.

1. A. handle structure and LCD arrangement of a DVD player comprising a LCD case, a handle structure, and a mold formed of a female die and a male die and adapted to mold said handle structure on said LCD case, said handle structure comprising a transversely extended top grip, and a hand hole defined below said top grip, said top grip protruding perpendicularly from said LCD case to a distance, said female die comprising a cavity adapted to mold said top grip, said male die comprising a protruding portion insertable into said cavity and adapted to mold said hand hole.

2. The handle structure and LCD arrangement of a DVD player as claimed in claim 1, wherein said LCD case is comprised of a front shell and a back shell.

3. The handle structure and LCD arrangement of a DVD player as claimed in claim 1, wherein said handle structure further comprises a bottom support disposed at a bottom side of said hand hole.

4. The handle structure and LCD arrangement of a DVD player as claimed in claim 1, wherein said top grip has an outer side terminating in a downwardly extended flange.

5. The handle structure and LCD arrangement of a DVD player as claimed in claim 3, wherein the protruding portion of said male die is inserted into a lower side of the cavity of said female die, thereby defining the cavity into a transversely extended top molding space and a vertically extended side molding space adapted to mold said top grip and said downwardly extended flange.

6. The handle structure and LCD arrangement of a DVD player as claimed in claim 1, wherein said female die and said male die further define therein, when closed, a longitudinal molding space and an angled molding space adapted to mold said support.
